(19) United States
(12) Patent Application Publication
(10) Pub. No.: US 2022/0245298 A1
(43) Pub. Date: Aug. 4, 2022

(54) DYNAMIC STABILITY ANALYSIS METHOD AND DEVICE FOR LINEAR TIME-PERIODIC SYSTEM

(71) Applicants: HUAZHONG UNIVERSITY OF SCIENCE AND TECHNOLOGY, Hubei (CN); China Electric Power Research Institute, Beijing (CN); State Grid Anhui Electric Power Research Institute, Anhui (CN)

(72) Inventors: Jiabing Hu, Hubei (CN); Jianhang Zhu, Hubei (CN); Shicong Ma, Beijing (CN); Yingbiao Li, Hubei (CN); Tiezhu Wang, Beijing (CN); Jianbo Guo, Beijing (CN); Zhen Wang, Anhui (CN)

(73) Assignees: HUAZHONG UNIVERSITY OF SCIENCE AND TECHNOLOGY, Hubei (CN); China Electric Power Research Institute, Beijing (CN); State Grid Anhui Electric Power Research Institute, Anhui (CN)

(21) Appl. No.: 17/509,063

(22) Filed: Oct. 25, 2021

(30) Foreign Application Priority Data
Jan. 29, 2021 (CN) 202110130204.7

(51) Int. Cl. G06F 30/20; G06F 17/14

(52) U.S. Cl. CPC G06F 30/20; G06F 2119/12; G06F 17/14

(57) ABSTRACT

The disclosure discloses a dynamic stability analysis method and device for a linear time-periodic (LTP) system. The method includes the following steps. Calculate the Q matrix corresponding to the LTP system, and use the eigenvalue of Q matrix whose real part is positive as an instability eigenvalue. Each instability eigenvalue is subjected to the following steps. (S1) the state space model is transformed into the infinite-order harmonic state space (HSS) model, and the truncation order m of HSS model is initialized to 1. (S2) after m-th order truncation of the HSS model, its eigenvalue thereof is calculated. If the real part of the eigenvalue of HSS model is not the same as the real part of the instability eigenvalue, m is updated, and step (S2) is performed again; otherwise, modal participation factor analysis is performed to obtain the state variables that dominate the system instability.

### CROSS-REFERENCE TO RELATED APPLICATION

This application claims the priority benefit of China application No. 202110130204.7, filed on Jan. 29, 2021. The entirety of the above-mentioned patent application is hereby incorporated by reference herein and made a part of this specification.

### BACKGROUND

### Field of the Disclosure

The disclosure belongs to the field of linear time-periodic system analysis, and more specifically, relates to a dynamic stability analysis method and device for a linear time-periodic system.

### Description of Related Art

In the actual physical world, nonlinearity and time-varying are the basic characteristics of system motion. In the analysis of nonlinear systems, the original nonlinear system can be linearized under certain assumptions, so as to use the linear system dynamic stability analysis theory to study the motion stability in the neighborhood of the steady-state equilibrium point of the nonlinear system. Since the original characteristics of the system are time-varying, the linear system obtained is a linear time-periodic system (LTP). When the system parameters change very slowly with time, it can be approximately regarded as a constant parameters system. Under the circumstances, the linear time-periodic system is approximately a classic linear time-invariant system. The difference between the two is whether the parameters that describe the system contain time-related parameters. In a generalized linear time-periodic system, there is a special kind of time-varying system, that is, the time-varying parameters of the system are periodic. Under the circumstances, the system is also called linear time-periodic system. Specifically, the classic linear time-invariant system can be regarded as a linear time-periodic system with any periodic. Therefore, the linear time-invariant system is a special kind of linear time-periodic system. In the meantime, compared with the classic linear time-invariant system, the linear time-periodic system is more universal and closer to engineering reality.

Although the difference between a linear time-periodic system and a linear time-invariant system only lies in whether the coefficients of the state equations of the two systems vary with time, such difference defines the essential difference between the motion characteristics of the two systems, and also defines the substantial difference between the analysis methods of the two systems.

The space state model of the linear time-periodic system can be expressed as:

\dot{x}(t)=A(f)x(t)+B(t)u(t) (1)

In the expression, x(t)=[x₁(t), . . . ,xₙ(t)]^{T} is the n-dimensional state vector of the system; u(t)=[u₁(t), . . . ,uₚ(t)]^{T} is the p-dimensional input vector of the system; n is the order of the system; A(t) and B(t) are n×n-dimensional and n×p-dimensional time-varying parameter matrices, respectively; how the system stability is determined is irrelevant to input vector u(t), and therefore u(t) is usually set to zero.

The time-varying parameter matrix A(t) contained in the space state model shown in equation (1) satisfies:

A(t)=A(t+T) (2)

In the equation, T is the minimum period.

The existing control theory can prove that the generalized form of the solution of the differential equation of the linear time-periodic system can be expressed as:

x(t)=Φ(t,t₀)x₀+∫ₜ_{₀}^{t}Φ(t,τ)B(τ)u(τ)dτ, t≥t₀ (3)

In the expression, Φ(t, t₀) is the state transition matrix of the linear time-periodic system.

The state transition matrix of the linear time-invariant system only depends on the difference between the observation time t and the initial time t₀. Unlike the linear time-invariant system, the linear time-periodic system has a direct dependence on the selection of the initial time t₀. In addition, due to the time-varying nature of parameter matrix of the linear time-periodic system, it is difficult to determine the analytical expressions of its differential equations except for extremely simple cases.

According to the Floquet-Lyapunov theory, when the input vector u(t) of the linear time-periodic system is zero, there is a time-periodic transformation matrix P(t), and the equation (1) can be transformed into:

v(t)=P(t)x(t)⇄\dot{v}(t)=(P(t)A(t)+\dot{P}(t))P⁻¹(t)v(t)=Qv(t) (4)

Since the P(t) matrix is non-singular and periodic, and therefore bounded, the P(t) is a transformation matrix in the sense of Lyapunov, and the stability of the system is unchanged before and after the transformation. Therefore, after any linear time-periodic system undergoes P(t) transformation, a linear time-invariant system equivalent to the stability of the original system can be obtained. From the uniqueness of the equation solution before and after the transformation, the state transition matrix of the linear time-periodic system can be expressed as:

Φ(t,t₀)=P⁻¹(t)e^{Q(t-t}^{₀}) (5)

When time t is T and t₀ is 0, the following can be obtained through equation (5):

Φ(T,0)=P⁻¹(T)e^{QT}=P⁻¹(0)e^{QT}=e^{QT} (6)

Although Floquet-Lyapunov theory explains the existence of P(t) matrix, it does not provide an analytical solution method for P(t) matrix. In most cases, it is difficult to achieve the analytical solution for P(t). For the obtained Q matrix of the linear time-invariant system, its eigenvalue is called the Floquet characteristic exponent, and the sign of the real part of the eigenvalue determines the stability of the system. It can be obtained from equation (6) that the stability of the linear time-periodic system is determined by the position of the eigenvalues of the state transition matrix Φ(T, 0) in the unit circle of the complex plane. The eigenvalues of the matrix Φ(T, 0) are called Floquet characteristic multiplier. In addition, in the process of using the matrix Φ(T, 0) to solve the Q matrix numerically, it is necessary to use the matrix exponential function, and the output of the function is the only logarithm whose eigenvalue has an imaginary part strictly between −π and π. When the frequency corresponding to the minimum period is f₀, the imaginary part of the Floquet characteristic exponent calculated by the matrix exponential function lies between [−πf₀, πf₀], so the frequency represented by the imaginary part of the Floquet characteristic exponent is different from the actual oscillation frequency of the fundamental frequency f₀ multiplying by positive integer, and the multiple cannot be calculated. Therefore, Floquet-Lyapunov theoretical analysis can strictly complete the judgment of system stability, but also encounters the deficiency of oscillation frequency information and the inability to quantitatively analyze the degree of participation of state variables in system instability modes.

In view of the challenges brought by the Floquet-Lyapunov theoretical analysis for the linear time-periodic system, the period time variable in the state space equation of the linear time-periodic system is expanded by Fourier series in complex exponential form. Meanwhile, by using the principle of harmonic balance, the relationships between the amplitude of various frequencies are established. Under the circumstances, the state space equation with time-varying coefficients is transformed into an infinite-order time-invariant model, so as to realize the time-invariant processing of the time-varying model. This method is also called harmonic state space modeling for linear time-periodic system. Since the theoretical harmonic state space model is an infinite-order model, it needs to be truncated in the actual operation process, and the truncation order is the key to the accuracy of the model. In order to ensure the accuracy of the model, the existing analysis methods often preset a truncation order. After the truncation order is determined, the analysis method of the linear time-invariant system with a complete theoretical system can be used to analyze the dynamic stability of the system, and the dominant factors that affect the stability of the system can be further explored. However, the existing theoretical knowledge cannot provide sufficient support for the rationality of the truncation order of the harmonic state space model. If the truncation order is too low, the information of the state variables that dominate the system instability will be lost, and the analysis results will be inaccurate; if the truncation order is too large, when the system is too large, the state space model of the infinite-order harmonic will no longer be applicable.

### SUMMARY OF THE DISCLOSURE

In view of the defects and the needs for improvement of the current technologies, the disclosure provides a dynamic stability analysis method and device for linear time-periodic system. While realizing the judgment on dynamic stability of the linear time-periodic system, it is possible to reasonably determine the order of truncation for the infinite-order harmonic state space model, thereby accurately determining the state variables that dominate the system instability.

To achieve the above purpose, according to an aspect of the disclosure, a dynamic stability analysis method for a linear time-periodic system is provided, which includes:

An instability eigenvalues acquisition step: The Q matrix of the linear time-invariant system corresponding to the linear time-periodic system is calculated, and the eigenvalue of the Q matrix is calculated, and each eigenvalue whose real part is positive is used as an instability eigenvalue.

An instability state variable analysis step: the following steps (S1)˜(S2) are performed to analyze the corresponding state variables that dominate the system instability for the instability eigenvalue to be analyzed.

(S1) The state space model of the linear time-periodic system is transformed into an infinite-order harmonic state space model, and the truncation order is initialized m=1.

(S2) After m-th order truncation of the infinite-order harmonic state space model, its eigenvalues thereof are calculated, and determine whether the eigenvalue whose real part is the same as the real part of the instability eigenvalue to be analyzed appears. If the result is no, the value of the truncation order m is updated according to m=m+1, and step (S2) is performed again. Otherwise, modal participation factor analysis is performed on the truncated infinite-order harmonic state space model to obtain the state variables that dominate the system instability.

An instability analysis step: The instability eigenvalue acquisition step is performed to obtain the instability eigenvalue of the linear time-periodic system. If the number of obtained instability eigenvalue is 0, it is determined that the system is stable. If the number of obtained instability eigenvalue is greater than 0, then it is determined that the system is unstable, and each instability eigenvalue is subjected to the instability state analysis step to obtain the state variables that dominate the system instability.

According to the Floquet-Lyapunov theory, the eigenvalue of the Q matrix of the linear time-invariant system corresponding to the linear time-periodic system is the Floquet characteristic exponent. The real part of the Floquet characteristic exponent represents the damping of the system, and the imaginary part is related to the oscillation frequency of the system. The disclosure first uses the real part of the Floquet characteristic exponent to determine the stability of the system. Specifically, when there is a Floquet characteristic exponent with a positive real part, it is determined that the system is unstable. Otherwise, it is determined that the system is stable. In this manner, it is possible to accurately determine the stability of the system. Meanwhile, the system oscillation frequency information carried by the imaginary part of the Floquet characteristic exponent can provide a clear basis for taking corresponding measures. In the disclosure, under the condition of using the Floquet characteristic exponent to determine the system instability, the infinite-order harmonic state space model is further utilized to analyze the state variables that dominate the system instability.

During the analysis, the truncation order is gradually increased, and it is observed whether the truncated infinite-order harmonic state space model has an eigenvalue whose real part is the same as the real part of the instability eigenvalue to be analyzed appears, and the result obtained from the above observation serves as the basis for determining whether the truncated infinite-order harmonic state space model can correctly analyze the problem of system instability.

In this manner, it is possible to ensure the accurate analysis of the state variables that dominate system instability. On the basis of ensuring the accuracy of the analysis, a smaller truncation order is adopted as often as possible, so that the infinite-order harmonic state space is applicable for large-scale system analysis.

Further, in the instability eigenvalue acquisition step, the step of calculating the Q matrix of the linear time-invariant system corresponding to the linear time-periodic system includes:

The n column vectors of the unit matrix I of order n is taken as the n initial states of the linear time-periodic system at initial time zero, and the state space model of the linear time-periodic system is adopted to calculate the n state values of the linear time-periodic system at time T. The n state values are respectively used as the n column vectors of the state transition matrix Φ(T, 0) to obtain the state transition matrix Φ(T, 0). n is the order of the linear time-periodic system, and T is the minimum period of the linear time-periodic system.

The Q matrix of the linear time-invariant system corresponding to the linear time-periodic system is calculated according to

$$Q = \frac{ln ( Φ ( T , 0 ) )}{T} .$$

Since the state transition matrix Φ(T, 0) is not affected by the initial state, the initial state can be selected from any n-dimensional linear maximum independent group. The disclosure directly selects n column vectors (or row vectors) of the n-dimensional unit matrix I as the initial state of the linear time-periodic system. The n state values of the calculated linear time-periodic system at time T are the n column vectors of the state transition matrix Φ(T, 0), thereby effectively simplifying the calculation of Q matrix.

Further, in step (S1), the state space model of the linear time-periodic system is transformed into the infinite-order harmonic state space model by using the Fourier series expansion and the principle of harmonic balance.

Further, in the instability eigenvalue acquisition step and the instability state variable analysis step, ode45, which is a MATLAB function, is adopted to calculate the eigenvalue.

Further, the dynamic stability analysis method for the linear time-periodic system provided by the disclosure further includes: after determining the system instability and analyzing the state variables that dominate the system instability, a measure corresponding to the state variables that dominate the system instability can be adopted to restore stability of the system.

According to another aspect of the disclosure, a dynamic stability analysis device for a linear time-periodic system is provided, including: an instability eigenvalue acquisition module, an instability state variable analysis module, and an instability analysis module.

The instability eigenvalue acquisition module is configured to calculate the Q matrix of the linear time-invariant system corresponding to the linear time-periodic system, and calculate the eigenvalue of the Q matrix, and each eigenvalue whose real part is positive is regarded as an instability eigenvalue.

The instability state variable analysis module is configured to analyze the corresponding state variables that dominate the system instability for the instability eigenvalue to be analyzed.

The instability state variable analysis module includes: an initialization unit, a truncation unit, a control unit, and a modal participation factor analysis unit.

The initialization unit is configured to transform the state space model of the linear time-periodic system into an infinite-order harmonic state space model, and initialize the truncation order m=1.

The truncation unit is configured to perform m-th order truncation on the infinite-order harmonic state space model and trigger the control unit.

The control unit is configured to calculate the eigenvalue of the truncated infinite-order harmonic state space model, and determine whether an eigenvalue whose real part is the same as the real part of the instability eigenvalue to be analyzed appears. If the result is no, the value of the truncation order m is updated according to m=m+1, and the truncation unit is triggered. Otherwise, the modal participation factor analysis unit is triggered.

The modal participation factor analysis unit is configured to analyze the modal participation factor for the truncated infinite-order harmonic state space model to obtain the state variables that dominate the system instability.

The instability analysis module is configured to obtain the instability eigenvalue of the linear time-periodic system by using the instability eigenvalue acquisition module. If the number of obtained instability eigenvalue is 0, it is determined that the system is stable. If the number of obtained instability eigenvalue is greater than 0, then it is determined that the system is unstable, and each instability eigenvalue is analyzed by the instability state analysis module to obtain the state variables that dominate the system instability.

According to another aspect of the disclosure, a computer-readable storage medium is provided, including a computer program that is stored therein.

When the computer program is executed by the processor, the device in which the computer-readable storage medium is located is controlled to execute the dynamic stability analysis method for the linear time-periodic system provided by the disclosure.

In general, through the above technical solutions conceived in the disclosure, the following advantageous effects can be achieved:

(1) The disclosure uses the real part of the Floquet characteristic exponent as the theoretical basis for the truncation of the infinite-order harmonic state space model, which provides theoretical support for the accurate application of the harmonic state space model in different situations, and avoids inaccurate analysis results caused by low truncation order. The disclosure also avoids using larger truncation orders. In this manner, while it is possible to accurately analyze the state variables that dominate system instability, the infinite-order harmonic state space model can be applied in large systems.

(2) On the basis of using the space state model of linear time-periodic system to determine the system stability, the disclosure uses the infinite-order harmonic state space model to further analyze the state variables that dominate the system instability, and integrates the advantages of the state space model of linear time periodic system and the harmonic state space model. Moreover, the analysis results of the two models can support and complement each other, thereby accurately determining the system stability and determining the state variables that dominate the system instability, and further providing theory support for optimization of system parameters and design of additional optimization controller.

(3) The disclosure uses the real part of the Floquet characteristic exponent of the linear time-periodic system to determine the stability of the system. The real part of Floquet characteristic exponent represents the damping of the system, so the physical significance is clearer. Meanwhile, the truncation problem encountered by the harmonic state space model can be avoided, so the accuracy is higher.

(4) The disclosure uses the real part of the Floquet characteristic exponent of the linear time-periodic system to determine system stability. While accurately determining the system stability, the system oscillation frequency information carried by the imaginary part of the Floquet characteristic exponent can provide a clear basis for adopting a corresponding measure.

### BRIEF DESCRIPTION OF THE DRAWINGS

FIG. 1 is a flow chart of a dynamic stability analysis method for a linear time-periodic system provided by an embodiment of the disclosure.

FIG. 2 is a flow chart of solving the state transition matrix Φ(T, 0) provided by an embodiment of the disclosure.

### DESCRIPTION OF EMBODIMENTS

In order to make the purposes, technical solutions, and advantages of the disclosure clearer, the following further describes the disclosure in detail with reference to the accompanying drawings and embodiments. It should be understood that the specific embodiments described here are only used to explain the disclosure, but not to limit the disclosure. In addition, the technical features involved in the various embodiments of the disclosure described below can be combined with each other as long as they do not conflict with each other.

In the disclosure, the terms “first”, “second”, etc. (if any) in the disclosure and the drawings are used to distinguish similar objects, and not necessarily used to describe a specific sequence or order.

In order to solve the technical problem that there is a lack of theoretical support for the reasonability of truncated order of the existing infinite-order harmonic state space model, the disclosure provides a dynamic stability analysis method and device for linear time-periodic system. The whole concept is to use the real part of Floquet characteristic exponent to determine system stability. When it is determined that the system is unstable, the real part of Floquet characteristic exponent is used as the theoretical basis for truncation of the infinite-order harmonic state space model to determine the minimum truncation order that can be used to correctly analyze system instability. While ensuring the accuracy of analysis, the infinite-order harmonic state space model can be applied to large systems.

Examples are provided as follows.

### EXAMPLE 1

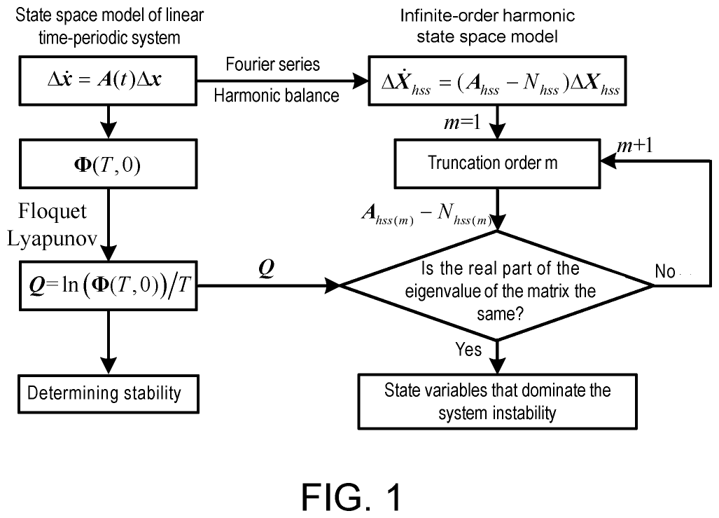

A dynamic stability analysis method for linear time-periodic system, as shown in FIG. 1, includes: an instability eigenvalue acquisition step, an instability state variable analysis step, and an instability analysis step.

In the embodiment, the instability eigenvalue acquisition step specifically includes: The Q matrix of the linear time-invariant system corresponding to the linear time-periodic system is calculated, and the eigenvalue of the Q matrix (namely Floquet characteristic exponent) is calculated, and each eigenvalue whose real part is positive is used as an instability eigenvalue.

Based on the Floquet-Lyapunov theory, the state transition matrix Φ(T, 0) and the Q matrix satisfy:

Φ(T,0)=P⁻¹(T)e^{QT}=P⁻¹(0)e^{QT}=e^{QT}.

After solving the state transition matrix Φ(T, 0), the Q matrix can be calculated.

According to the physical significance of the state transition matrix, under its action, the system state is transitioned from the state value x(t₀) at the initial time t₀ to the state x(t) at the observation time t. Therefore, when the initial time to is zero, the observation time t is the minimum period T, and the matrix Φ(T, 0) satisfies:

$$x ( T ) = Φ ( T , 0 ) x ( 0 ) = [ \begin{matrix}{ϕ}_{11} ( T , 0 ) & {ϕ}_{12} ( T , 0 ) & … & {ϕ}_{1 n} ( T , 0 ) \\ {ϕ}_{21} ( T , 0 ) & {ϕ}_{22} ( T , 0 ) & … & {ϕ}_{2 n} ( T , 0 ) \\ ⋮ & ⋮ & ⋱ & ⋮ \\ {ϕ}_{n 1} ( T , 0 ) & {ϕ}_{n 2} ( T , 0 ) & … & {ϕ}_{nn} ( T , 0 )\end{matrix} ] [ \begin{matrix}{x}_{1} ( 0 ) \\ {x}_{2} ( 0 ) \\ ⋮ \\ {x}_{n} ( 0 )\end{matrix} ] .$$

Since the state transition matrix Φ(T, 0) is not affected by the initial state, the initial state can be selected from any n-dimensional linear maximum independent group.

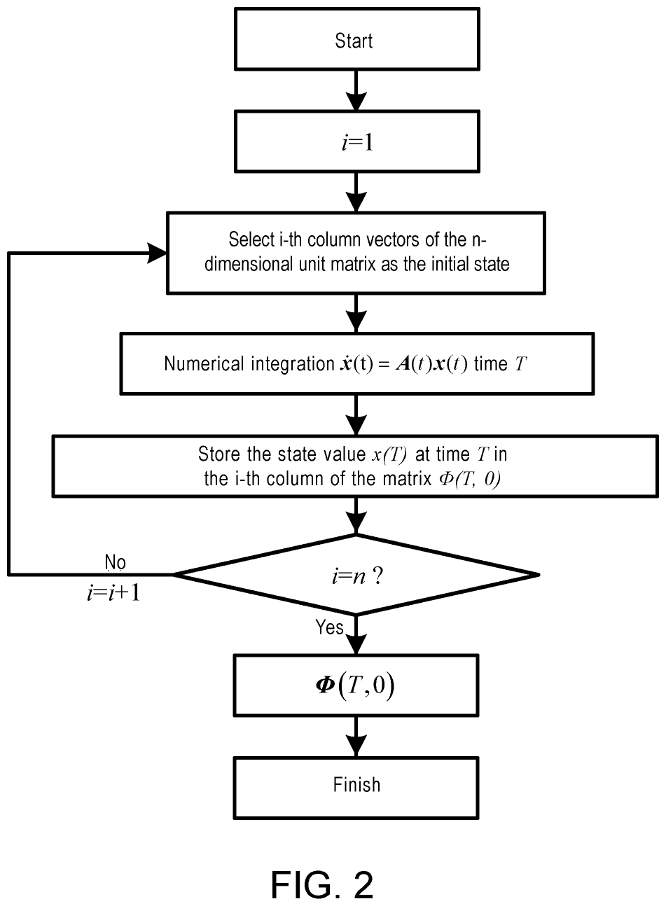

In order to simplify related calculations, in a preferred embodiment, the embodiment directly selects n column vectors of the n-dimensional unit matrix I as the initial state of the linear time-periodic system. Then the response x(T) of the n states of the linear time-periodic system is n column vectors of the state transition matrix Φ(T, 0) respectively. Correspondingly, as shown in FIG. 2, in the instability eigenvalue acquisition step of this embodiment, the step of calculating the Q matrix of the linear time-invariant system corresponding to the linear time-periodic system includes:

The n column vectors of the n-th order unit matrix I is taken as the n initial states of the linear time-periodic system at initial time zero.

Based on the n initial states that are set at initial time zero, the state space model of the linear time-periodic system is adopted, that is \dot{x}(t)=A(t)x(t), to calculate the n state values of the linear time-periodic system at time T. The specific calculations can be performed by directly using the numerical integration of MATLAB, and the corresponding calculation equation is as follows:

$$x ( 0 ) = {e}_{1} [ \begin{matrix}1 \\ 0 \\ ⋮ \\ 0\end{matrix} ] = {\to }^{ Φ ( T , 0 ) } x ( T ) = [ \begin{matrix}{ϕ}_{11} ( T , 0 ) \\ {ϕ}_{21} ( T , 0 ) \\ ⋮ \\ {ϕ}_{n 1} ( T , 0 )\end{matrix} ] = {ϕ}_{1} ( T , 0 )$$

$$x ( 0 ) = {e}_{2} [ \begin{matrix}0 \\ 1 \\ ⋮ \\ 0\end{matrix} ] = {\to }^{ Φ ( T , 0 ) } x ( T ) = [ \begin{matrix}{ϕ}_{12} ( T , 0 ) \\ {ϕ}_{22} ( T , 0 ) \\ ⋮ \\ {ϕ}_{n 2} ( T , 0 )\end{matrix} ] = {ϕ}_{2} ( T , 0 )$$

$$⋮⋮$$

$$x ( 0 ) = {e}_{n} [ \begin{matrix}0 \\ 0 \\ ⋮ \\ 1\end{matrix} ] = {\to }^{ Φ ( T , 0 ) } x ( T ) = [ \begin{matrix}{ϕ}_{1 n} ( T , 0 ) \\ {ϕ}_{2 n} ( T , 0 ) \\ ⋮ \\ {ϕ}_{nn} ( T , 0 )\end{matrix} ] = {ϕ}_{n} ( T , 0 )$$

The obtained n state values at time T are respectively used as the n column vectors of the state transition matrix Φ(T, 0) to obtain the state transition matrix Φ(T, 0); n is the order of the linear time-periodic system, and T is the minimum period of the linear time-periodic system.

After calculating the state transition matrix Φ(T, 0), the Q matrix of the linear time-invariant system corresponding to the linear time-periodic system is calculated according to

$$Q = \frac{ln ( Φ ( T , 0 ) )}{T} .$$

Optionally, in this embodiment, the eigenvalues of the Q matrix can be calculated by using ode45, which is a numerical calculation method provided by MATLAB. In some other embodiments of the disclosure, in consideration of actual calculation accuracy requirements, other numerical calculation methods can also be adopted to calculate eigenvalue.

In this embodiment, as shown in FIG. 1, the instability state variable analysis step specifically includes: the following steps (S1)˜(S2) are performed to analyze the corresponding state variables that dominate the system instability for the instability eigenvalue to be analyzed.

(S1) The state space model of the linear time-periodic system is transformed into an infinite-order harmonic state space model, and the truncation order is initialized m=1. In the embodiment, the specific implementation is that the state space model of the linear time-periodic system is transformed into the infinite-order harmonic state space model by using the Fourier series expansion and the principle of harmonic balance.

In this embodiment, the calculation equation of the infinite-order harmonic state space model is Δ\dot{x}ₕₛₛ=(Aₕₛₛ−Nₕₛₛ)Δxₕₛₛ. In the equation, Xₕₛₛ represents the amplitude of each frequency after Fourier decomposition of x(t), and the related calculation equation is:

Xₕₛₛ=[ . . . , X₋₂, X₋₁, X₀, X₁, X₂, . . . ]^{T}

Correspondingly, Aₕₛₛ represents the amplitude of each frequency after Fourier decomposition of A(t), and the related calculation equation is:

$${A}_{hss} = [ \begin{matrix}⋱ & ⋮ & ⋮ & ⋮ & ⋰ \\ … & {A}_{0} & {A}_{- 1} & {A}_{- 2} & … \\ … & {A}_{1} & {A}_{0} & {A}_{- 1} & … \\ … & {A}_{2} & {A}_{1} & {A}_{0} & … . \\ ⋰ & □ & □ & □ & ⋱\end{matrix} ]$$

Nₕₛₛ represents the diagonal matrix calculated by using the n-dimensional unit matrix E and the n-dimensional zero matrix O, and the related calculation equation is:

Nₕₛₛ=diag[ . . . −2jω₀E−jω₀E O jω₀E 2jω₀E . . . ].

(S2) After m-th order truncation of the infinite-order harmonic state space model, its eigenvalue thereof is calculated, and determine whether the eigenvalue whose real part is the same as the real part of the instability eigenvalue to be analyzed appears. If the result is no, the value of the truncation order m is updated according to m=m+1, and step (S2) is performed again. Otherwise, modal participation factor analysis is performed on the truncated infinite-order harmonic state space model to obtain the state variables that dominate the system instability.

Aₕₛₛ₍ₘ₎ is the matrix of Aₕₛₛ₍ₘ₎ after m-th order truncation, and Nₕₛₛ₍ₘ₎ is the matrix of Nₕₛₛ after m-th order truncation; taking m=2 as an example, after m-th order truncation,

$${A}_{hss ( 2 )} = [ \begin{matrix}{A}_{0} & {A}_{- 1} & {A}_{- 2} & 0 & 0 \\ {A}_{1} & {A}_{0} & {A}_{- 1} & {A}_{- 2} & 0 \\ {A}_{2} & {A}_{1} & {A}_{0} & {A}_{- 1} & {A}_{- 2} \\ 0 & {A}_{2} & {A}_{1} & {A}_{0} & {A}_{- 1} \\ 0 & 0 & {A}_{2} & {A}_{1} & {A}_{0}\end{matrix} ] ;$$

$${N}_{hss ( 2 )} = diag [ - 2 j {ω}_{0} E - j {ω}_{0} E O j {ω}_{0} E 2 j {ω}_{0} E ] .$$

Optionally, in this embodiment, the eigenvalue of the truncated infinite-order harmonic state space model can be calculated by using ode45, which is a function of MATLAB. In some other embodiments of the disclosure, in consideration of actual calculation accuracy requirements, other numerical calculation methods can also be adopted to calculate eigenvalue.

In this embodiment, the instability analysis step specifically includes: using the instability eigenvalue acquisition step to obtain the instability eigenvalue of the linear time-periodic system. If the number of obtained instability eigenvalue is 0, it is determined that the system is stable. If the number of obtained instability eigenvalue is greater than 0, then it is determined that the system is unstable, and each instability eigenvalue is subjected to the instability state analysis step to obtain the state variables that dominate the system instability.

According to the Floquet-Lyapunov theory, the eigenvalue of the Q matrix of the linear time-invariant system corresponding to the linear time-periodic system is the Floquet characteristic exponent. The real part of the Floquet characteristic exponent represents the damping of the system, and the imaginary part is related to the oscillation frequency of the system. The embodiment first uses the real part of the Floquet characteristic exponent to determine the stability of the system. Specifically, when there is a Floquet characteristic exponent with a positive real part, it is determined that the system is unstable. Otherwise, it is determined that the system is stable. In this manner, it is possible to accurately determine the stability of the system. Meanwhile, the system oscillation frequency information carried by the imaginary part of the Floquet characteristic exponent can provide a clear basis for taking corresponding measures. In the embodiment, under the condition of using the Floquet characteristic exponent to determine the system instability, the infinite-order harmonic state space model is further utilized to analyze the state variables that dominate the system instability.

During the analysis, the truncation order is gradually increased, and it is observed whether the truncated infinite-order harmonic state space model has an eigenvalue whose real part is the same as the real part of the instability eigenvalue to be analyzed, and the result obtained from the above observation serves as the basis for determining whether the truncated infinite-order harmonic state space model can correctly analyze the problem of system instability. In this manner, it is possible to ensure the accurate analysis of the state variables that dominate system instability. On the basis of ensuring the accuracy of the analysis, a smaller truncation order is adopted as often as possible, so that the infinite-order harmonic state space model is applicable for large-scale system analysis.

Optionally, the embodiment may further include: after determining the system instability and analyzing the state variables that dominate the system instability, a measure corresponding to the state variables that dominate the system instability can be adopted to restore stability of the system.

### EXAMPLE 2

A dynamic stability analysis device for linear time-periodic system, including: an instability eigenvalue acquisition module, an instability state variable analysis module, and an instability analysis module.

The instability eigenvalue acquisition module is configured to calculate the Q matrix of the linear time-invariant system corresponding to the linear time-periodic system, and calculate the eigenvalue of the Q matrix, and each eigenvalue whose real part is positive is used as an instability eigenvalue.

The instability state variable analysis module is configured to analyze the corresponding state variables that dominate system instability for the instability eigenvalue to be analyzed.

The instability state variable analysis module includes: an initialization unit, a truncation unit, a control unit, and a modal participation factor analysis unit.

The initialization unit is configured to transform the state space model of the linear time-periodic system into an infinite-order harmonic state space model, and initialize the truncation order m=1.

The truncation unit is configured to perform m-th order truncation on the infinite-order harmonic state space model and trigger the control unit.

The control unit is configured to calculate the eigenvalue of the truncated infinite-order harmonic state space model, and determine whether an eigenvalue whose real part is the same as the real part of the instability eigenvalue to be analyzed. If the result is no, the value of the truncation order m is updated according to m=m+1, and the truncation unit is triggered. Otherwise, the modal participation factor analysis unit is triggered.

The modal participation factor analysis unit is configured to analyze the modal participation factor for the truncated infinite-order harmonic state space model to obtain the state variables that dominate the system instability.

The instability analysis module is configured to obtain the instability eigenvalue of the linear time-periodic system by using the instability eigenvalue acquisition module. If the number of obtained instability eigenvalue is 0, it is determined that the system is stable. If the number of obtained instability eigenvalue is greater than 0, then it is determined that the system is unstable, and each instability eigenvalue is analyzed by the instability state analysis module to obtain the state variables that dominate the system instability.

In this embodiment, the specific implementation of each module can be derived from the description in the above Example 1, and no further description is incorporated herein.

### EXAMPLE 3

A computer-readable storage medium includes a computer program that is stored therein.

When the computer program is executed by the processor, the device in which the computer-readable storage medium is located is controlled to execute the dynamic stability analysis method for the linear time-periodic system provided in the Example 1.

Those skilled in the art can easily understand that the above are only the preferred embodiments of the disclosure and are not intended to limit the disclosure. Any modification, equivalent replacement and improvement, etc. made within the spirit and principle of the disclosure should fall within the protection scope of the disclosure.

What is claimed is:

1. A dynamic stability analysis method for a linear time-periodic system, comprising:
an instability eigenvalue acquisition step: calculating a Q matrix of a linear time-invariant system corresponding to the linear time-periodic system, and calculating eigenvalues of the Q matrix, and using each of the eigenvalues whose real part being positive as an instability eigenvalue;
an instability state variable analysis step: performing the following steps (S1)˜(S2) to analyze corresponding state variables that dominate system instability for the instability eigenvalue to be analyzed:
(S1) transforming a state space model of the linear time-periodic system into an infinite-order harmonic state space model, and initializing a truncation order m=1;
(S2) after m-th order truncation of the infinite-order harmonic state space model, calculating its eigenvalue thereof, and determining whether an eigenvalue whose real part is the same as a real part of the instability eigenvalue to be analyzed, if a result is no, updating a value of the truncation order m according to m=m+1, and performing step (S2) again; otherwise, performing a modal participation factor analysis on the truncated infinite-order harmonic state space model to obtain the state variables that dominate the system instability;
an instability analysis step: performing the instability eigenvalue acquisition step to obtain the instability eigenvalue of the linear time-periodic system, if a number of obtained instability eigenvalue is 0, determining that the system being stable; if the number of the obtained instability eigenvalue is greater than 0, then determining that the system being unstable, and each of the instability eigenvalues being subjected to the instability state analysis step to obtain the state variables that dominating the system instability.

2. The dynamic stability analysis method for the linear time-periodic system according to claim 1, wherein in the instability eigenvalue acquisition step, the step of calculating the Q matrix of the linear time-invariant system corresponding to the linear time-periodic system comprises:
taking n column vectors of a unit matrix I of order n as n initial states of the linear time-periodic system at initial time zero, and adopting the state space model of the linear time-periodic system to calculate n state values of the linear time-periodic system at a time T, respectively using the n state values as the n column vectors of a state transition matrix Φ(T, 0) to obtain the state transition matrix Φ(T, 0); wherein n is the order of the linear time-periodic system, and T is the minimum period of the linear time-periodic system;
calculating the Q matrix of the linear time-invariant system corresponding to the linear time-periodic system according to
$$Q = \frac{ln ( Φ ( T , 0 ) )}{T} .$$

3. The dynamic stability analysis method for the linear time-periodic system according to claim 1, wherein in the step (S1), the state space model of the linear time-periodic system is transformed into the infinite-order harmonic state space model by using Fourier series expansion and a principle of harmonic balance.

4. The dynamic stability analysis method for the linear time-periodic system according to claim 1, wherein in the instability eigenvalue acquisition step and the instability state variable analysis step, ode45 is adopted to calculate the eigenvalue.

5. The dynamic stability analysis method for the linear time-periodic system according to claim 1, further comprising: after determining the system instability and analyzing the state variables that dominate the system instability, adopting a measure corresponding to the state variables that dominate the system instability to restore stability of the system.

6. A dynamic stability analysis device for a linear time-periodic system, comprising: an instability eigenvalue acquisition module, an instability state variable analysis module, and an instability analysis module;
wherein the instability eigenvalue acquisition module is configured to calculate a Q matrix of a linear time-invariant system corresponding to the linear time-periodic system, and calculate an eigenvalue of the Q matrix, and each of the eigenvalues whose real part is positive is regarded as an instability eigenvalue,
wherein the instability state variable analysis module is configured to analyze corresponding state variables that dominate system instability for the instability eigenvalue to be analyzed,
wherein the instability state variable analysis module comprises: an initialization unit, a truncation unit, a control unit, and a modal participation factor analysis unit,
wherein the initialization unit is configured to transform a state space model of the linear time-periodic system into an infinite-order harmonic state space model, and initialize a truncation order m=1,
wherein the truncation unit is configured to perform m-th order truncation on the infinite-order harmonic state space model and trigger the control unit,
wherein the control unit is configured to calculate the eigenvalue of the truncated infinite-order harmonic state space model, and determine whether an eigenvalue whose real part is the same as a real part of the instability eigenvalue to be analyzed appears, if a result is no, a value of the truncation order m is updated according to m=m+1, and the truncation unit is triggered; otherwise, the modal participation factor analysis unit is triggered, wherein the modal participation factor analysis unit is configured to analyze the modal participation factor for the truncated infinite-order harmonic state space model to obtain the state variables that dominate the system instability,
wherein the instability analysis module is configured to obtain the instability eigenvalue of the linear time-periodic system by using the instability eigenvalue acquisition module, if the number of obtained instability eigenvalue is 0, it is determined that the system is stable; if the number of obtained instability eigenvalue is greater than 0, then it is determined that the system is unstable, and each of the instability eigenvalues is analyzed by the instability state analysis module to obtain the state variables that dominate the system instability.

7. A computer-readable storage medium, comprising a computer program that is stored therein;
wherein when the computer program is executed by a processor, a device in which the computer-readable storage medium is located is controlled to execute the dynamic stability analysis method for the linear time-periodic system claimed in claim 1.

8. The dynamic stability analysis method for the linear time-periodic system according to claim 2, further comprising: after determining the system instability and analyzing the state variables that dominate the system instability, adopting a measure corresponding to the state variables that dominate the system instability to restore stability of the system.

9. The dynamic stability analysis method for the linear time-periodic system according to claim 3, further comprising: after determining the system instability and analyzing the state variables that dominate the system instability, adopting a measure corresponding to the state variables that dominate the system instability to restore stability of the system.

10. The dynamic stability analysis method for the linear time-periodic system according to claim 4, further comprising: after determining the system instability and analyzing the state variables that dominate the system instability, adopting a measure corresponding to the state variables that dominate the system instability to restore stability of the system.

11. A computer-readable storage medium, comprising a computer program that is stored therein;
wherein when the computer program is executed by a processor, a device in which the computer-readable storage medium is located is controlled to execute the dynamic stability analysis method for the linear time-periodic system claimed in claim 2.

12. A computer-readable storage medium, comprising a computer program that is stored therein;
wherein when the computer program is executed by a processor, a device in which the computer-readable storage medium is located is controlled to execute the dynamic stability analysis method for the linear time-periodic system claimed in claim 3.

13. A computer-readable storage medium, comprising a computer program that is stored therein;
wherein when the computer program is executed by a processor, a device in which the computer-readable storage medium is located is controlled to execute the dynamic stability analysis method for the linear time-periodic system claimed in claim 4.

14. A computer-readable storage medium, comprising a computer program that is stored therein;
wherein when the computer program is executed by a processor, a device in which the computer-readable storage medium is located is controlled to execute the dynamic stability analysis method for the linear time-periodic system claimed in claim 5.
